(19) United States
(12) Patent Application Publication
(10) Pub. No.: US 2011/0147444 A1
(43) Pub. Date: Jun. 23, 2011

(54) Outside Web Corner Barrier Carton

(75) Inventor: Kelly R. Fitzwater, Lakewood, CO (US)

(73) Assignee: GRAPHIC PACKAGING INTERNATIONAL, INC., Marietta, GA (US)

(21) Appl. No.: 12/971,514

(22) Filed: Dec. 17, 2010

Related U.S. Application Data
(60) Provisional application No. 61/287,291, filed on Dec. 17, 2009.

(51) Int. Cl. B65D 5/42; B65D 5/64; B31B 1/26; B31B 1/62

(52) U.S. Cl. 229/154; 229/198.2; 493/84; 493/102; 493/128; 493/162

(57) ABSTRACT

A carton includes a front panel, a back panel and a side panel. End panels are respectively foldably connected to the front and back panels for at least partially closing an end of the carton, and a web panel is foldably connected to each of the side panel and the end panels. The web panel may be folded away from the end of the carton and be connected to the outer surface of the side panel. The folding of the web panel tensions the end panels and pinches respective panels of the carton together to at least partially seal the end of the carton that is closed by the end panels.

### CROSS-REFERENCE TO RELATED APPLICATION

This application claims the benefit of U.S. Provisional Application No. 61/287,291, which was filed on Dec. 17, 2010.

### INCORPORATION BY REFERENCE

The entire disclosure of U.S. Provisional Application No. 61/287,291, which was filed on Dec. 17, 2010, is incorporated herein by reference.

### BACKGROUND

Bag-in-box cartons (i.e., cartons that include an interior bag for containing one or more items) are known. However, in some instances, it may be desirable to place items in the carton without using a bag (e.g., using a direct fill process). At the same time, a sufficient barrier may be needed to prevent product loss and/or contamination. Thus, there is a need for a carton with sufficient barrier properties that can contain items securely without the need for a bag.

### SUMMARY

This disclosure is directed generally to a package or carton that may be used for holding food or other contents. This disclosure is also directed to a blank for forming such a carton, and to a method of making and using such a carton.

In accordance with one embodiment of this disclosure, the carton comprises a plurality of panels that extends at least partially around an interior of the carton. In one example, the plurality of panels includes a front panel, a back panel and a side panel. End panels are respectively foldably connected to the front and back panels for at least partially closing an end of the carton, and a web panel is foldably connected to each of the side panel and the end panels. The web panel may be folded away from the end of the carton (e.g., folded outwardly) and be connected (e.g., with adhesive material) to the outer surface of the side panel. The folding of the web panel tensions the end panels and “pinches” respective panels of the carton together to at least partially seal the end of the carton that is closed by the end panels. If desired, an adhesive coating or any other suitable barrier may be applied to the exterior of the carton, such as over the outwardly folded web corner, to further seal the carton (e.g., the corners of the carton) and thereby provide an additional barrier in an effort to minimize product loss and/or contamination.

The carton may find particular use in containing granular, powdered, or particulate items, for example, food items such as cake mixes, pancake mixes, flour, and sugar. However, the carton may be used to contain any other suitable food item or non-food item.

Other aspects of this disclosure will become apparent from the following description and accompanying figures.

### BRIEF DESCRIPTION OF THE DRAWINGS

The description refers to the accompanying schematic drawings in which like reference characters refer to like parts throughout the several views, and in which:

FIG. 1A is a perspective view of an exemplary carton, in a closed configuration, in accordance with a first embodiment of this disclosure.

FIG. 1B is a plan view of an exemplary blank for forming the carton of FIG. 1A.

FIG. 1C is a perspective view of a tubular structure erected from the blank of FIG. 1B.

FIG. 1D is a perspective view of the carton of FIG. 1A with an upper opening in a partially closed configuration.

FIG. 1E is a perspective view of the carton of FIG. 1A with an upper opening in a substantially closed configuration.

FIG. 2A is a plan view of an exemplary blank for forming a carton in accordance with a second embodiment of this disclosure.

FIG. 2B is a perspective view of an exemplary carton formed from the blank of FIG. 2A.

### DESCRIPTION

Various aspects of this disclosure may be understood further by referring to the figures. For purposes of simplicity, like numerals may be used to describe like features. Where a plurality of similar features are depicted in the figures, not all of such features necessarily are labeled on each figure. Also, the various components used to form the cartons of this disclosure may be interchanged. Thus, while only certain combinations are illustrated herein, numerous other combinations, subcombinations, and configurations are contemplated hereby.

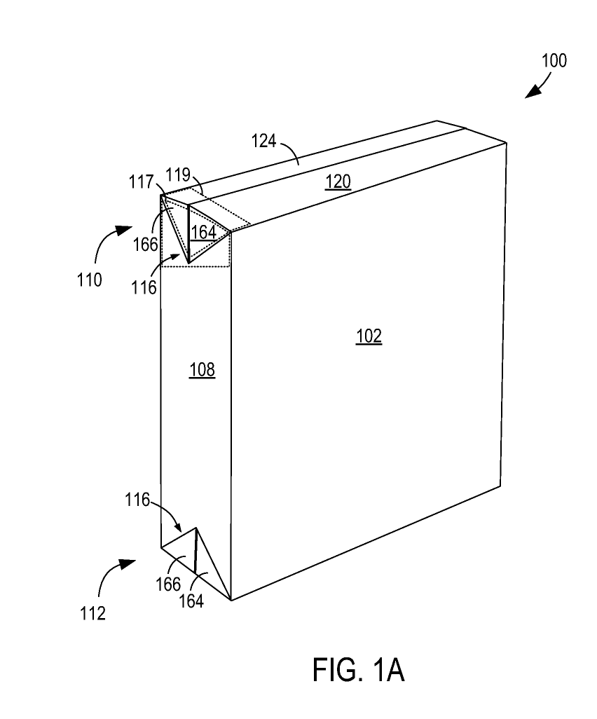

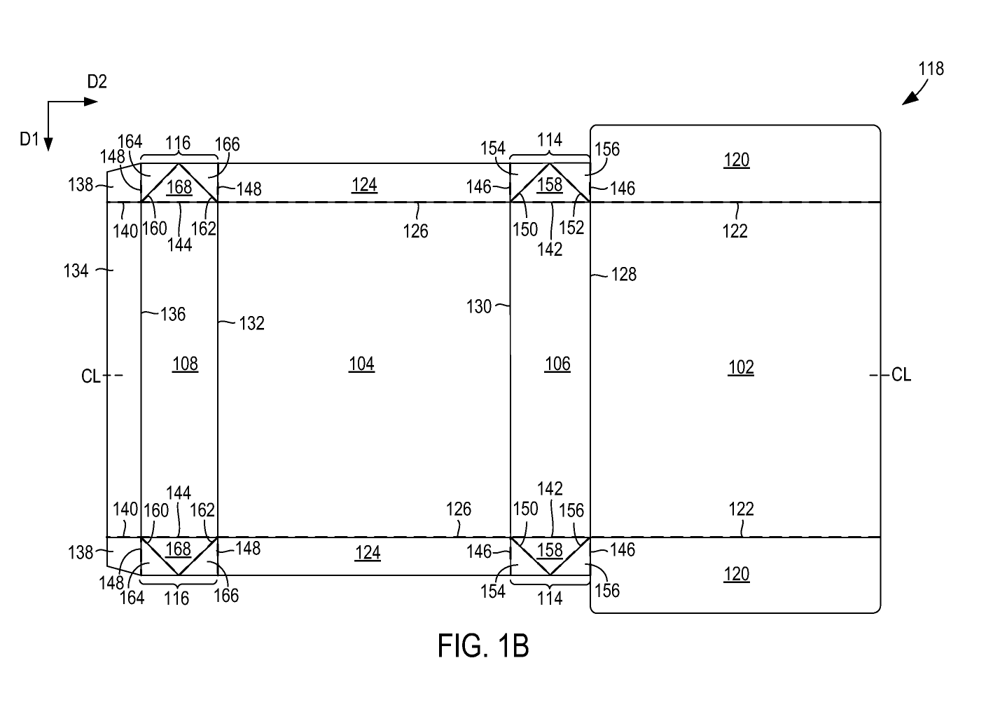

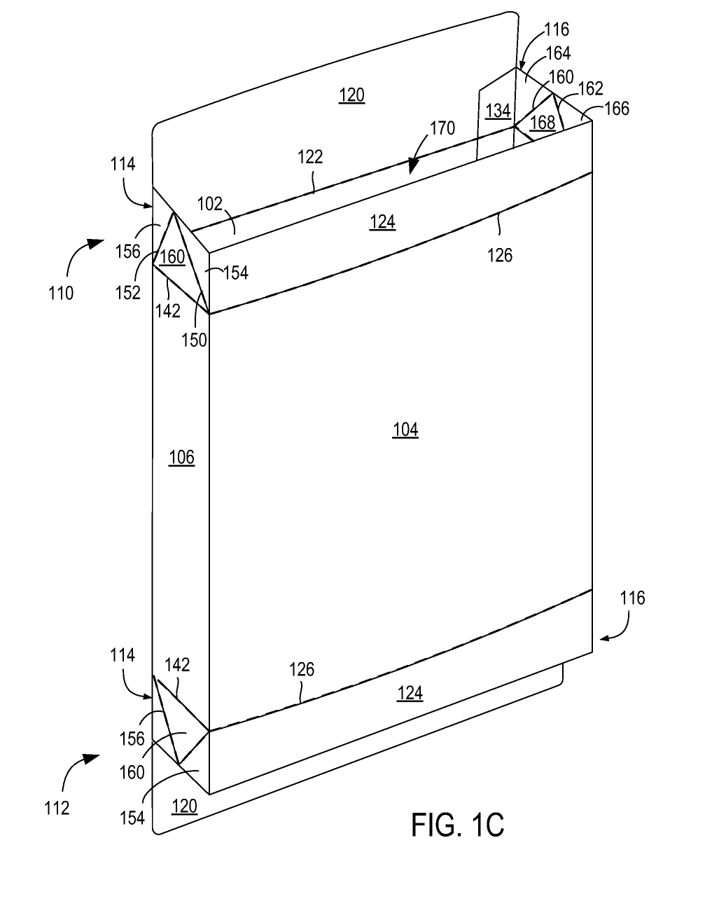

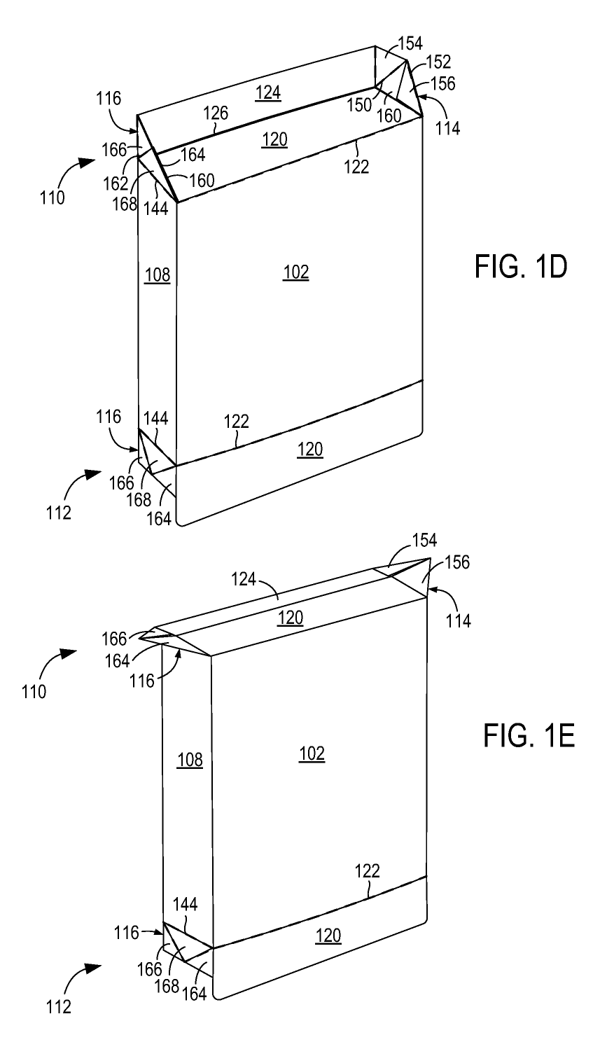

In the following, a first embodiment of this disclosure is discussed with reference to FIGS. 1A-1E. FIG. 1A schematically illustrates an exemplary package for containing food item(s) or other article(s), in a closed configuration. The package may more specifically be referred to as a carton 100. Generally described, the carton 100 includes a plurality of wall panels that extend at least partially around an interior space 170 (FIG. 1C) of the carton. More specifically, the carton 100 includes a front wall panel 102, a back wall panel 104 (FIG. 1B) and a pair of opposed side wall panels 106, 108 (FIG. 1B).

Generally described, the carton 100 includes a plurality of end panels that respectively at least partially close the opposite ends of the carton. More specifically, each of the opposite ends of the carton 100 includes an end closure assembly 110, 112 that includes one or more of the end panels. For example, each end closure assembly 110, 112 includes a respective pair of web panels 114, 116 (FIG. 1B) and a respective pair of end panels 120, 124 (FIG. 1B).

In the closed configuration of the carton 100 of the first embodiment, each of the end panels 120, 124, in its entirety, is substantially planar, and at least partially closes the end of the carton 100, and the web panels 114, 116 (FIG. 1B) are adjacent to and connected to the outer surface of the respectively adjacent side wall panel 106, 108 (FIG. 1B) by an adhesive material 117 (shown schematically in FIG. 1A on one web panel 116 with dashed lines) or otherwise disposed between the respective web panel 114, 116 and respective side wall panel 106, 108. Additionally, if desired, an overcoat 119 (shown schematically in FIG. 1A on one web panel 116 with dashed lines) of adhesive material, an overwrap, or any other suitable layer may be applied over the web panels 114, 116 and optionally at least a portion of the side wall panels 106, 108 and/or various panels of the end closure assembly 110, 112 to provide an enhanced barrier against leakage and/or contamination. Alternatively, the web panels 114, 116 may be respectively held in opposing face-to-face relation (e.g., opposing face-to-face contact) with the outer surface of the respective side wall panel 106, 108 by way of mechanical faster(s) or any other suitable mechanism(s).

FIG. 1B schematically illustrates an exemplary blank 118 for forming the carton 100 of FIG. 1A. The blank 118 generally includes a plurality of panels having edges that are respectively connected along lines of disruption, for example, fold lines, tear lines, score lines, or any other suitable lines of weakening or disruption. The blank 118 and each of the various panels generally has a first dimension, for example, a length, extending in a first direction, for example, a longitudinal direction, D1, and a second dimension, for example, a width, extending in a second direction, for example, a transverse direction, D2. It will be understood that such designations are made only for convenience and do not necessarily refer to or limit the manner in which the blank is manufactured or erected into the carton 100. The blank 118 may be symmetric or nearly symmetric about a transversely extending centerline CL. Therefore, certain elements in the drawing figures may have similar or identical reference numerals to reflect the whole or partial symmetry.

As shown in FIG. 1B, the blank 118 includes a first main wall panel 102 and a second main wall panel 104 that generally form the front and back walls of the carton 100. A pair of major end panels 120 is connected to transversely extending, opposite end edges of the first main wall panel 102 along respective transversely extending lines of disruption (e.g., fold lines 122). Likewise, a pair of minor end panels 124 is connected to transversely extending, opposite end edges of the second main wall panel 104 along respective transversely extending lines of disruption (e.g., fold lines 126).

The major end panels 120 and the minor end panels 124 have the same (e.g., substantially the same) second dimension that extends in the transverse direction D2. The major end panels 120 have a first dimension, which extends in the longitudinal direct D1, that is greater than the first dimension of the minor end panels 124. In one particular example, the minor end panels 124 have a first dimension that is about one-half the first dimension of the major end panels 120.

The blank 118 also includes a pair of the minor wall panels 106, 108 that generally form side panels of the carton 100. A longitudinally extending edge of a first minor wall panel 106 is connected to a longitudinally extending edge of the first main wall panel 102 along a longitudinally extending line of disruption (e.g., fold line 128). The opposite longitudinally extending edge of the first minor wall panel 106 is connected to a longitudinally extending edge of the of the second main wall panel 104 along a longitudinally extending line of disruption (e.g., fold line 130). A longitudinally extending edge of a second minor wall panel 108 is connected to a longitudinally extending edge of the second main wall panel 104 along a longitudinally extending line of disruption (e.g., fold line 132). The blank 118 also includes a glue flap or attachment panel 134 connected to a longitudinally extending edge of the second main wall panel 104 along a longitudinally extending line of disruption (e.g., fold line 136). A pair of attachment end panels 138 is connected to opposite ends of the attachment panel 134 along transversely extending lines of disruption (e.g., fold lines 140). In this example, the panels 102, 104, 106, 108, 134 and longitudinally extending fold lines 128, 130, 132, 136 have substantially the same first dimension. However, other panel shapes and configurations are contemplated.

Transversely extending edges of web panels 114, 116 are respectively foldably connected to transversely extending, opposite end edges of the wall panels 106, 108 along respective transversely extending lines of disruption (e.g., fold lines 142, 144). The web panels 114 extend between and are foldably connected to the major end panels 120 and the minor end panels 124. More specifically, substantially the entire length of longitudinally extending edges of the web panels 114 are foldably connected to longitudinally extending edges of the major and minor end panels 120, 124 along longitudinally extending lines of disruption (e.g., fold lines 146). The web panels 116 extend between and are foldably connected to the minor end panels 124 and attachment end panels 138. More specifically, substantially the entire length of longitudinally extending edges of the web panels 116 are foldably connected to longitudinally extending edges of the minor end panels 124 and attachment end panels 138 along respective longitudinally extending lines of disruption (e.g., fold lines 148). As shown in FIG. 1B, each of the web panels' outermost transversely extending edges (i.e., the web panels' transversely extending edges that are respectively opposite from the fold lines 142, 144) is at least one of the plurality of peripheral edges that define the outermost periphery of the blank 118.

Each web panel 114, 116 generally includes three substantially triangular portions or panels (e.g., pleat panels) defined by a pair of oblique lines of disruption. For example, each of the web panels 114 include a first oblique line of disruption 150 that extends substantially from an interior corner of the web panel 114 (proximate to the intersection of the panels 104, 106, 124) substantially to a midpoint of the peripheral edge of the web panel 114 opposite the fold line 142. A second oblique line of disruption 152 extends substantially from another interior corner of web panel 114 (proximate to the intersection of panels 102, 106, 120) substantially to a midpoint of the peripheral edge of web panel 114 opposite fold line 142. Thus, the oblique lines of disruption 150, 152 (e.g., fold lines) extend convergently from the corners of web panel 114 toward the midpoint of the peripheral edge of web panel 114.

Each web panel 114 includes a first portion (e.g., pleat panel 154) disposed between fold lines 146, 150 (adjacent to end panel 124), a second portion (e.g., pleat panel 156) disposed between fold lines 146, 152 (adjacent to end panel 120), and a third portion (e.g., pleat panel 158) between fold lines 142, 150, 152 (adjacent to wall panel 106). Pleat panels 154, 156, 158 substantially form the web panels 114.

Likewise, the web panels 116 each include a first line of disruption 160 that extends substantially from an interior corner of web panel 116 (proximate to the intersection of panels 108, 134, 138) substantially to a midpoint of the peripheral edge of web panel 116 opposite fold line 144. A second line of disruption 162 extends substantially from another interior corner of web panel 116 (proximate to the intersection of panels 104, 108, 124) substantially to a midpoint of the peripheral edge of web panel 116 opposite fold line 144. Thus, lines 160, 162 extend convergently from the corners of web panel 116 toward the midpoint of the peripheral edge of web panel 116.

Each web panel 116 includes a first portion (e.g., pleat panel 164) disposed between fold lines 148, 160 (adjacent to attachment end panel 138), a second portion (e.g., pleat panel 166) disposed between fold lines 148, 162 (adjacent to end panel 124), and a third portion (e.g., pleat panel 168) between fold lines 144, 160, 162 (adjacent to wall panel 108). Pleat panels 164, 166, 168 substantially form the web panels 116.

It will be noted that in this example, lines of disruption 122, 126, 142, 144, 146, 148, 150, 152, 160, 162 are shown as cut-crease lines (e.g., score lines that include a plurality of spaced apart cuts (e.g., kiss cuts)) to facilitate folding. However, any other suitable type of line of disruption may be used.

To form the carton 100 (FIG. 1A) from the blank 118 according to one acceptable method, attachment panel 134 may be brought into contact with the free marginal edge of wall panel 102 (opposite fold line 128) by folding along a respective two of the fold lines 128, 130, 132, 136. The attachment panel 134 may be connected to wall panel 102 adhesively or otherwise. The resulting flat tubular structure may be “opened” to form an open tubular structure having a pair of open ends and an interior space 170, as shown in FIG. 1C.

If desired, a food item or other contents may be inserted into the tubular structure through one or both open ends of the open tubular structure. Typically, the food or other contents is inserted into one of the open ends of the carton 100 after the other end of the carton has been closed. In accordance with one example of the first embodiment, the contents of the carton 100 are not within a bag that is within the interior 170 of the carton. Alternatively, the contents of the carton 100 may be within a bag or bags that are within the interior of the carton 100.

After forming the open tubular structure shown in FIG. 1C, each end closure assembly 110, 112 may then be closed by folding end panel 120 towards the interior space 170 along line of disruption 122. At the same time, web panels 114, 116 may be urged outwardly somewhat, folding along lines of disruption 142, 150, 156, 144, 160, 162 as needed. End panel 120 then may be folded to be substantially perpendicular to wall panel 102, as shown in FIG. 1D. As shown in FIG. 1D, the end panel 120 extends more than half way across (e.g., at least about two thirds of the way across, or substantially all the way across) the upper end opening of the carton 100 in a direction extending along the fold line 144 (e.g., in a direction extending along the foldably connected edges of the web panel 116 and the wall panel 108). More specifically and as shown in FIG. 1D, the end panel 120 extends substantially completely to each of the fold line 126 (e.g., the foldably connected edges of the end panel 124 and the wall panel 104), the fold line 144 (e.g., the foldably connected edges of the web panel 116 and the wall panel 108), and the fold line 142 (FIG. 1B) (e.g., the foldably connected edges of the web panel 114 and the wall panel 102).

Next, end panel 124 may be folded along line of disruption 126 towards end panel 120 until end panel 124 is in a substantially facing, contacting relationship with end panel 120, as shown in FIG. 1E. As apparent from FIGS. 1D and 1E, the end panel 124 extends no more than about half way across the opening of the carton in the direction extending along the fold line 144 (e.g., in a direction extending along foldably connected edges of the web panel 116 and the wall panel 108). Alternatively, the end panel 124 may extend more than half way across, at least about two thirds of the way across, or substantially all the way across the upper end opening of the carton in the direction extending along the fold line 144.

In response to the end panels 120, 124 each being substantially planar and extending substantially parallel to one another, and being in the substantially facing, contacting relationship shown in FIG. 1E, the free peripheral edges of pleat panels 154, 156 are brought into a facing relationship with one another, and the interior side of pleat panels 154, 156 is brought into in a substantially contacting, facing relationship with the (originally) interior side of pleat panel 158. In this configuration, the pleat panels 154, 156 at least partially cover (e.g., substantially cover) the pleat panel 158. Likewise, the free peripheral edges of pleat panels 164, 166 are brought into a facing relationship with one another, and the interior side of pleat panels 164, 166 is brought into a substantially contacting, facing relationship with the (originally) interior side of pleat panel 168. In this configuration, the pleat panels 164, 166 at least partially cover (e.g., substantially cover) the pleat panel 168.

As best understood with reference to FIG. 1A, the pleat panels 158, 168 are then brought into a substantially facing, contacting relationship with the respective exterior of side wall panels 106, 108. In doing so, the web panels 114, 116 urge the respective end panels 120, 124 towards the interior space 170, thereby at least partially sealing the corners of the carton 100. The web panels 114, 116 may be fastened to wall panels 106, 108 using an adhesive 117 (or otherwise) to form the closed carton 100 (FIG. 1A). As stated previously, an additional adhesive overcoat 119 (FIG. 1A) may be applied over the web panels 114, 116 and optionally at least a portion of the side wall panels 106, 108 and/or various panels of the end closure assembly 110, 112 (e.g., end panels 120, 124) to provide an enhanced barrier against leakage and/or contamination. Adhesive material also may be placed elsewhere, such as between the portion of end panels 120, 124 in an opposing, face-to-face contact with one another. Accordingly, respective ones of the panels 114, 116, 120, 124, 138 form each end closure assembly 110, 112 (FIG. 1C).

As should be apparent in view of this disclosure and in accordance with one aspect of the first embodiment, the openings (to the interior 170) at the ends of the carton 100 may be at least partially closed by inwardly folding the end panels 120, 124 so that at each end of the carton: one of the end panels 120, 124, in its entirety, is substantially planar, and at least partially closes the end of the carton; the other of the end panels 120, 124, in its entirety, is substantially planar and substantially parallel to the second end panel; and there is an overlapping relationship between the end panels 120, 124. In accordance with this aspect and at each end of the carton, the opening to the interior 170 may be at least partially sealed, comprising folding the web panels 114, 116 away from the end of the carton 100. The end panels 120, 124 are tensioned, urged inwardly, and respectively “pinched” together in response to the folding of the web panels 114, 116 away from the end of the carton 100.

In the configurations of FIGS. 1A and 1E, for each closely associated pair of the fold lines 146, the fold lines 146 (FIG. 1B) are substantially collinear with one another, and the fold lines 146 are substantially parallel to the respective fold line 142 (FIB. 1B). Similarly, for each closely associated pair of the fold lines 148, the fold lines 148 (FIG. 1B) are substantially collinear with one another, and the fold lines 148 are substantially parallel to the respective fold line 144 (FIB. 1B).

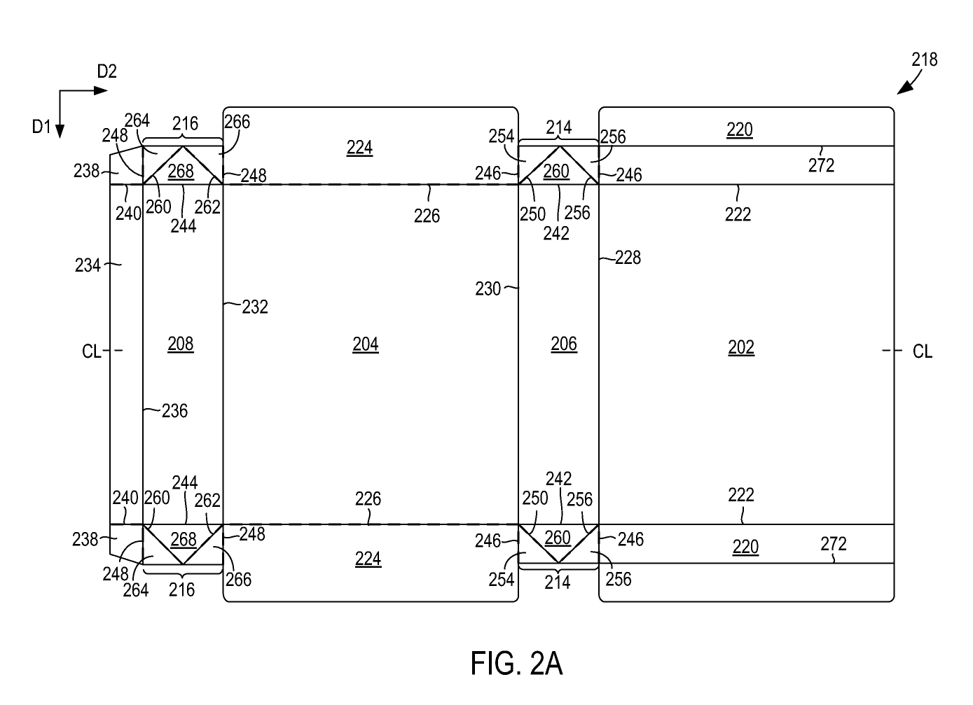

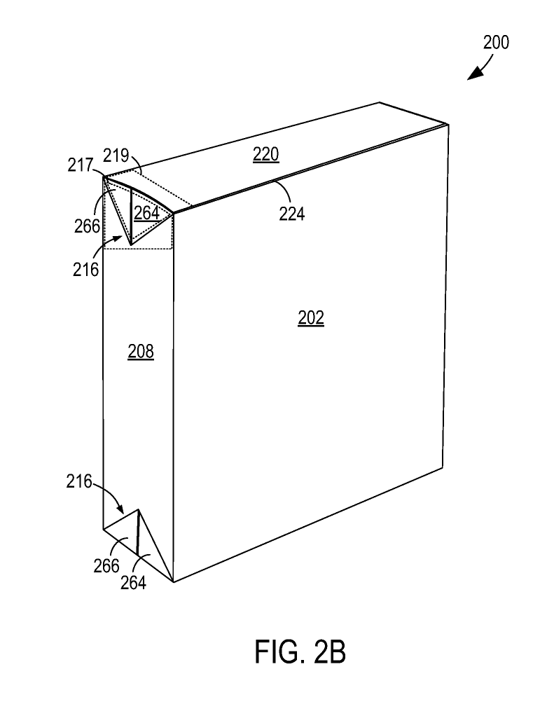

FIGS. 2A and 2B schematically depict a blank 218 and carton 200 in accordance with a second embodiment of this disclosure. The carton 200 and blank 218 include features that are similar to the carton 100 and blank 116 shown in FIGS. 1A-1E, except for variations noted and variations that will be understood by those of skill in the art. For simplicity, the reference numerals of similar features are preceded in the figures with a “2” instead of a “1”.

As shown in FIG. 2A, the major end panels 220 of this exemplary embodiment have a first dimension that is approximately equal to the first dimension of the minor end panels 224. Thus, when the carton 200 is erected, the major end panels 220 and the minor end panels 224 are substantially overlapped with one another, as shown in FIG. 2B. In accordance with the second embodiment, the end panels 224 extend substantially all the way across the end openings of the carton in the direction extending along the fold lines 244.

Also, in this example, the major end panels 220 include a transversely extending line of disruption, for example, a fold line or score line 272, for assisting with folding of the major end panels 220 inwardly towards the interior space.

Finally, in this example, the cut-crease lines 122, 142, 144 of the blank 118 of FIG. 1B are replaced with solely scored fold lines 222, 242, 244 in the blank 118 of FIG. 2A. However, any of the various lines of disruption of the blank 218 may be cut-crease lines or other suitable lines of disruption, as needed to facilitate erection of the carton 200.

The blanks and cartons of this disclosure may be formed from any suitable material. For example, they may be formed from paperboard having a basis weight of from about 60 to about 330 lbs/ream, for example, from about 80 to about 140 lbs/ream. The paperboard generally may have a thickness of from about 6 to about 30 mils, for example, from about 12 to about 28 mils. In one particular example, the paperboard has a thickness of about 12 mils. Any suitable paperboard may be used, for example, a solid bleached or solid unbleached sulfate board, such as SUS® board, commercially available from Graphic Packaging International.

If desired, one or more portions or sides of the various blanks or other cartons described herein or contemplated hereby may be coated with varnish, clay, or other materials, either alone or in combination. For example, at least the side of the blank or carton may be coated with a clay coating or other base coating. The coating may then be printed over with product advertising, images, price coding, any other information or indicia, or any combination thereof. The blank or carton then may be overcoated with a varnish to protect any information printed thereon.

Furthermore, the blanks or cartons may be coated with, for example, a moisture and/or oxygen barrier layer, on either or both sides, such as those described above. Any suitable moisture and/or oxygen barrier material may be used, for example, polyvinylidene chloride, ethylene vinyl alcohol, DuPont DARTEK™ nylon 6,6, or any other suitable material. Alternatively or additionally, any of the blanks or other cartons may be coated or laminated with other materials to impart other properties, such as absorbency, repellency, opacity, color, printability, stiffness, or cushioning.

It will be understood that in each of the various blanks and cartons described herein and contemplated hereby, a “fold line” can be any substantially linear, although not necessarily straight, form of weakening that facilitates folding therealong. More specifically, but not for the purpose of narrowing the scope of the present invention, a fold line may be a score line, such as a line formed with a blunt scoring knife, or the like, which creates a crushed portion in the material along the desired line of weakness, a cut that extends partially into a material along the desired line of weakness, and/or a series of cuts that extend partially into and/or completely through the material along the desired line of weakness; or any combination of these features.

Furthermore, various exemplary blanks and cartons are shown and described herein as having fold lines, tear lines, score lines, cut lines, kiss cut lines, and other lines as extending from a particular feature to another particular feature, for example from one particular panel to another, from one particular edge to another, or any combination thereof. However, it will be understood that such lines need not necessarily extend between such features in a precise manner. Instead, such lines may generally or substantially extend between the various features as needed to achieve the objective of such line. For instance, where a particular fold line is shown as extending from a first edge of a blank to another edge of the blank, the fold line need not extend completely to one or both of such edges. Rather, the fold line need only extend to a location sufficiently proximate to the edge so that the desired folding may be reasonably achieved.

While the present invention is described herein in detail in relation to specific aspects and embodiments, it is to be understood that this description is only illustrative and exemplary of the present invention and is made merely for purposes of providing a full and enabling disclosure of the present invention and to set forth the best mode of practicing the invention. The description set forth herein is illustrative only and is not intended, nor is to be construed, to limit the present invention or otherwise to exclude any such other embodiments, adaptations, variations, modifications, and equivalent arrangements of the present invention. An directional references (e.g., longitudinal, transverse, upper, lower, upward, downward, left, right, leftward, rightward, top, bottom, above, below, vertical, horizontal, clockwise, and counterclockwise) have been used in this description only for identification purposes to aid the reader's understanding of the various embodiments of this disclosure, and do not create limitations, particularly as to the position, orientation, or use of the invention unless specifically set forth in the claims. In this disclosure, joinder references (e.g., connected, attached, coupled, connected, and the like) are to be construed broadly and may include intermediate members between a connection of elements and relative movement between elements. As such, joinder references do not necessarily imply that two elements are connected directly and in fixed relation to each other. Further, various elements discussed with reference to the various embodiments may be interchanged to create entirely new embodiments coming within the scope of the present invention.

It will be understood by those skilled in the art that while the present disclosure has been discussed above with reference to exemplary embodiments, various additions, modifications and changes can be made thereto without departing from the spirit and scope of the invention as set forth in the claims.

What is claimed is:

1. A carton comprising:
a web panel extending away from an end of the carton, wherein
the web panel includes opposite first and second edges, and a third edge extending transversely to the first and second edges, and
the web panel includes first, second and third portions between which there has been relative folding so that
the second and third portions at least partially cover the first portion,
the first and second edges are substantially collinear with respect to one another and substantially parallel to the third edge; and
first and second end panels at least partially closing the end of the carton, wherein
the first end panel has a first edge foldably connected to the first edge of the web panel,
the second end panel has a first edge foldably connected to the second edge of the web panel,
the second end panel is positioned between the first end panel and an interior of the carton, and
the second end panel extends more than half way across the end of the carton in a direction extending along the third edge of the web panel.

2. The carton according to claim 1, wherein the second end panel extends substantially completely across the end of the carton in the direction extending along the third edge of the web panel

3. The carton according to claim 1, wherein the first end panel extends no more than about half way across the end of the carton in the direction extending along third edge of the web panel.

4. The carton according to claim 1, wherein:
the web panel includes oblique fold lines that at least partially define the first, second and third portions of the web panel;
the oblique fold lines extend obliquely relative to each of the first, second and third edges of the web panel; and
the oblique fold lines extend divergently with respect to one another toward the third edge of the web panel.

5. The carton according to claim 1, comprising a plurality of wall panels that extends at least partially around the interior of the carton, the plurality of wall panels including
a first wall panel having
opposite first and second longitudinally extending edges, and
an end edge extending crosswise to the first and second longitudinally extending edges, wherein the third edge of the web panel is foldably connected to the end edge of the first wall panel;
a second wall panel having
a longitudinally extending edge foldably connected the first longitudinally extending edge of the first wall panel, and
an end edge extending crosswise to the longitudinally extending edge of the second wall panel, wherein the first end panel has a second edge that
extends crosswise the first edge of the second end panel, and
is foldably connected to the end edge of the second wall panel; and
a third wall panel positioned across the interior of the carton from the second wall panel and having
a longitudinally extending edge foldably connected to the second longitudinally extending edge of the first wall panel, and
an end edge extending crosswise to the longitudinally extending edge of the third wall panel, wherein the second end panel has a second edge that
extends crosswise the first edge of the second end panel, and
is foldably connected to the end edge of the third wall panel.

6. The carton according to claim 5, wherein the second end panel extends substantially completely to both the end edge of the second wall panel and the second edge of the first end panel.

7. The carton according to claim 5, wherein:
the first wall panel includes
an interior surface facing towards the interior of the carton, and
an outer surface that is opposite from the interior surface; and
the web panel at least partially covers the outer surface of the first wall panel; and
the first portion of the web panel is positioned between the second and third portions of the web panel and the outer surface of the first wall panel.

8. The carton according to claim 5, wherein the first end panel extends at least about half way across the end of the carton in the direction extending along both the third edge of the web panel and the end edge of the first wall panel.

9. The carton according to claim 8, wherein the first end panel extends more than half way across the end of the carton in the direction extending along both the third edge of the web panel and the end edge of the first wall panel.

10. The carton according to claim 9, wherein the first end panel extends substantially completely to both the end edge of the third wall panel and the second edge of the second end panel.

11. The carton according to claim 1, wherein:
the carton is erected from a blank having a plurality of peripheral edges that define an outermost periphery of the blank while the blank is in an unerected, flat state;
the web panel includes a fourth edge that
is opposite from the third edge of the web panel, and
extends crosswise to the first and second edges of the web panel; and
the fourth edge of the web panel is at least one of the plurality of peripheral edges that define the outermost periphery of the blank.

12. The carton according to claim 11, wherein:
the web panel includes first and second oblique fold lines that extend obliquely relative to each of the first, second, third and fourth edges of the web panel;
the oblique fold lines extend from proximate the fourth edge of the web panel, which is the at least one of the plurality of peripheral edges that define the outermost periphery of the blank, divergently with respect to one another toward the third edge of the web panel; and
the oblique fold lines extend substantially completely to the fourth edge of the web panel, which is the at least one of the plurality of peripheral edges that define the outermost periphery of the blank.

13. A blank for being erected into a carton, the blank comprising:
a plurality of peripheral edges that define an outermost periphery of the blank;
a web panel including
opposite first and second longitudinally extending edges,
opposite first and second transversely extending edges that extend transversely to the first and second longitudinally extending edges,
oblique fold lines extending obliquely relative to each of the first and second longitudinally extending edges and the first and second transversely extending edges, wherein
the oblique fold lines extend substantially completely to the second transversely extending edge, and
the second transversely extending edge is at least one of the plurality of peripheral edges that define the outermost periphery of the blank; and
first and second end panels for at least partially closing an end of the carton when the carton is erected from the blank, wherein
the web panel is positioned between the first and second end panels,
the first end panel has a longitudinally extending edge foldably connected to the first longitudinally extending edge of the web panel, and
the second end panel has a longitudinally extending edge foldably connected to the second longitudinally extending edge of the web panel.

14. The blank according to claim 13, wherein the web panel includes first, second and third portions that are respectively at least partially defined by the oblique fold lines, the first and second longitudinally extending edges of the web panel, and the first and second transversely extending edges of the web panel.

15. The blank according to claim 13, comprising a plurality of wall panels for at least partially extending around an interior of the carton when the carton is erected from the blank, the plurality of wall panels including:
a first wall panel having
opposite first and second longitudinally extending edges, and
a transversely extending edge extending crosswise to the longitudinally extending first and second edges of the first wall panel, wherein the transversely extending edge of the first wall panel is foldably connected to the first transversely extending edge of the web panel;
a second wall panel having
a longitudinally extending edge foldably connected to the first longitudinally extending edge of the first wall panel, and
a transversely extending edge extending crosswise to the longitudinally extending edge of the second wall panel, wherein the transversely extending edge of the second wall panel is foldably connected to the transversely extending edge of the first end panel; and
a third wall panel having
a longitudinally extending edge foldably connected to the second longitudinally extending edge of the first wall panel, and
a transversely extending edge extending crosswise to the longitudinally extending edge of the third wall panel, wherein the transversely extending edge of the third wall panel is foldably connected to the transversely extending edge of the second end panel.

16. A method of at least partially closing an end of a carton with a first panel positioned between and foldably connected to second and third panels, the method comprising:
inwardly folding the second and third panels so that
the second panel, in its entirety, is substantially planar, and at least partially closes the end of the carton, and
the third panel, in its entirety, is substantially planar and substantially parallel to the second panel, and
there is an overlapping relationship between the second and third panels; and
at least partially sealing the end of the carton, comprising folding the first panel away from the end of the carton, wherein the second and third panels are tensioned and urged together in response to the folding of the first panel away from the end of the carton.

17. The method according to claim 16, wherein the second panel substantially closes the end of the carton.

18. The method according to claim 16, wherein simultaneously with the inwardly folding of the second and third panels:
the first panel is folded outwardly; and
there is relative folding between first, second and third portions of the first panel.

19. The method according to claim 16, wherein the inwardly folding of the second panel occurs prior to the inwardly folding of the third end panel.
